(19) United States
(12) Patent Application Publication
(10) Pub. No.: US 2007/0091976 A1
(43) Pub. Date: Apr. 26, 2007

(54) Edge emitting laser diode assembly having adjustable mounting of diodes

(76) Inventors: Curtis A. Ray, Alamo, CA (US); Eric B. Grann, San Ramon, CA (US)

Correspondence Address: Bruce H. Johnsonbaugh;Eckhoff & Hoppe, Suite 2800, 101 Montgomery Street, San Francisco, CA, 94104, US

(21) Appl. No.: 11/585,627

(22) Filed: Oct. 24, 2006

Related U.S. Application Data
(60) Provisional application No. 60/730,219, filed on Oct. 25, 2005.

(51) Int. Cl. H01S 3/08

(52) U.S. Cl. 372/107

(57) ABSTRACT

A novel edge emitting laser diode assembly with adjustable mounting of the diodes is described. A laser diode submount carrier is adjustably mounted onto a base assembly in such a manner as to compensate for variations in thickness of each of the edge emitting laser diodes. The laser array assembly is usable for applications in either parallel optical modules or wavelength-division multiplexing modules.

### CROSS-REFERENCE TO RELATED APPLICATION

This application claims the benefit of and priority from U.S. provisional application Ser. No. 60/730,219 filed Oct. 25, 2005.

### BACKGROUND AND BRIEF SUMMARY

The present invention pertains to optical communications. More particularly, this invention relates to the packaging of edge emitting laser diodes within an assembly that is usable in wavelength division multiplexing packages or parallel optical packages for fiber-optic data-communications and telecommunications systems. U.S. Pat. No. 6,201,908, incorporated by reference, describes a wavelength division multiplexer in which the present invention may be utilized.

Edge emitting diodes have become widely used, but their use in optical communications systems has been complicated by inherent variations in the thickness of the diodes. These variations (in diodes that are available at reasonable cost) can be as great as plus or minus 5 to 15 microns. Variations in diode thickness directly affect the location of the light emitting facet of the diode and the location of the output beam. Optical systems, such as wavelength division multiplexers, for example, require a precise location of laser output beams of within 1 micron so that the output beams are aligned with single mode fibers included in the optical pathway of the multiplexer. Variations in location of edge emitting laser diode output beams in the range of plus or minus 5 to 15 microns are simply unacceptable in these devices.

The present invention provides a cost effective, adjustable mounting system for edge emitting laser diodes that compensates for variations of thickness from diode to diode.

The present invention is similar to aligning a series of diving boards of unequal lengths so that the tip ends of the diving boards extending over a pool are aligned precisely. The length of each diving board is analogous to the thickness of an edge emitting diode. Providing a horizontally adjustable mounting for each diving board is analogous to the present invention, which provides an adjustable mounting for each diode which adjusts to compensate for variations of thickness from diode to diode.

A primary object of the invention is to provide a method and apparatus for adjustably mounting an array of edge emitting laser diodes to compensate for variations of thickness of the diodes.

Another object of the present invention is to provide a means of isolating the light emitting z-axis from the x-axis and y-axis of an edge-emitting laser diode.

Other objects and advantages will become apparent from the following description and drawings wherein:

### BRIEF DESCRIPTION OF THE DRAWINGS

FIG. 1 shows a prior art single edge emitting laser diode mounted horizontally with respect to the carrier and an optical power monitor mounted perpendicular to the carrier;

FIG. 2 shows a prior art for a single edge emitting laser diode mounted vertically with respect to the carrier and an optical power monitor mounted directly to the carrier;

FIG. 3 is a schematic illustration of thickness variations of prior art edge emitting diode lasers;

FIG. 4 is a schematic illustration showing how the present invention compensates for thickness Variations of edge emitting laser diodes;

FIG. 5 illustrates an array of four edge emitting laser diodes according to the invention; and

FIG. 6 illustrates a two dimensional, 2×2 array of four edge emitting laser diodes according to the invention.

### DETAILED DESCRIPTION OF THE PREFERRED EMBODIMENTS

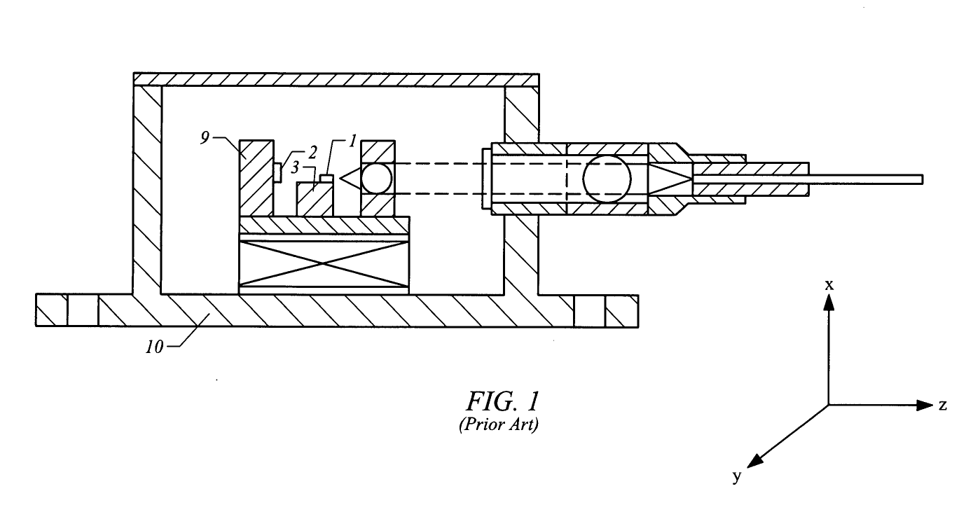

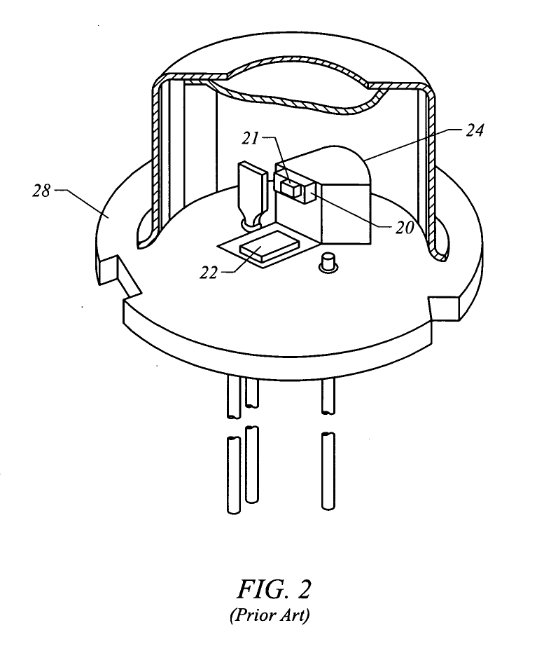

Most prior art edge emitting laser diode assemblies, such as shown in FIG. 1, attach the laser diode chip 1 horizontally on a fixed support 3 within the carrier assembly 10. A photo-monitor diode 2 is then typically mounted perpendicular to the carrier assembly to capture the light coming from the rear of the laser diode 1. In order to create a laser array with this type of assembly construction, the variations of the laser diode chip thickness (plus or minus 5 to 15 microns) becomes unmanageable, causing unacceptable variations in the vertical positioning of the horizontal laser output beam in this application. Prior art edge emitting laser diode assemblies that are mounted vertically within the carrier assembly, such as shown in FIG. 2, use a side-flattened metal post 24 on which to mount the edge emitting laser diode 21. Sometimes, a small conducting spacer chip 20 is used to increase the distance the facet of the laser diode extends out from the post. This allows one to place a photo-monitor diode 22 beneath the rear facet of the edge emitting laser diode 21 for monitoring of the optical power. Once again, in order to create a laser array, the tolerance on (or variations in) the laser diode chip thickness in this configuration becomes unmanageable. The invention described herein compensates for variations of thickness of edge emitting laser diodes by using a laser diode submount attached to the base of the assembly in such a manner as to extend along the y-axis of the assembly, like a diving board extends over a pool in the analogy described above. In creating an edge emitting laser diode array, the submounts of the laser diodes are positioned to align the light emitting facets of each laser diode with each other and with the optical system in which the diodes are working. The z-axis of the laser diode assembly is parallel to the laser output beam and is usually a coarse and non-critical alignment. The x-axis and y-axis are critical alignments and are controlled by the placement of the submount carrier relative to the base of the assembly. This isolation of the non-critical z-axis of the diodes relative to the critical x and y axes allows one to easily place multiple edge emitting lasers in a usable array with standard manufacturing tolerances. The cost of manufacture of the components and the arrays is significantly reduced.

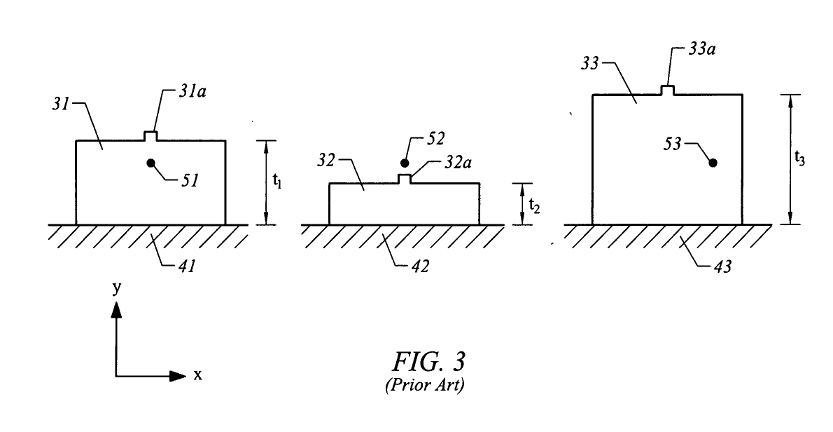

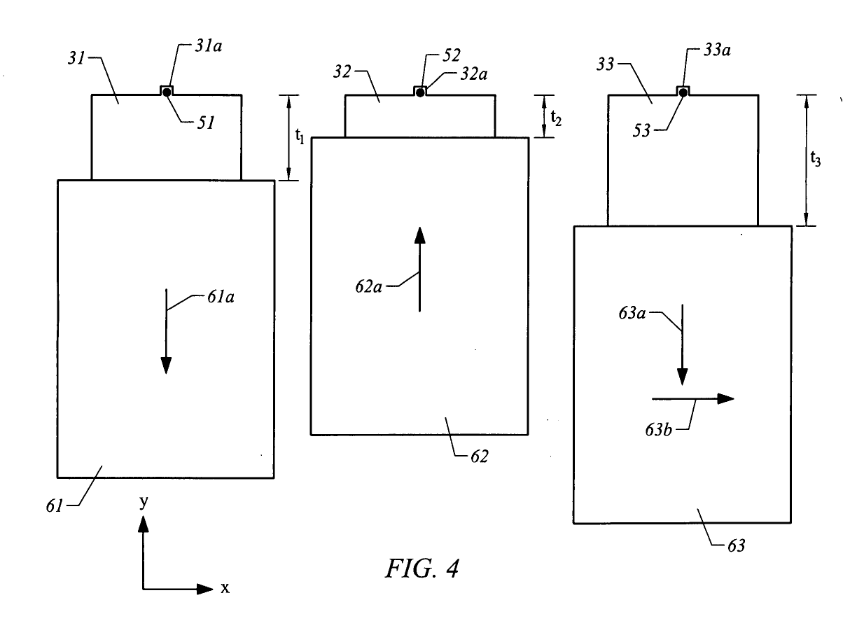

FIGS. 3 and 4 are schematic representations of how the present invention (FIG. 4) differs from the prior art (FIG. 3). FIGS. 3 and 4 are not to scale and are intended to illustrate the operation of the invention.

FIG. 3 illustrates a prior art array of three edge emitting laser diodes 31, 32 and 33 rigidly mounted to bases 41, 42 and 43, respectively. Each of the laser diodes 31, 32 and 33 has a thickness t₁, t₂ and t₃, respectively, wherein the thickness of each laser diode varies widely as described above. Each laser diode 31-33 has a light emitting facet 31a, 32a and 33a that emits an output beam upwardly and perpendicularly to the x and y plane as shown in FIG. 3. A series of three “alignment targets” 51, 52 and 53 are shown, which represent the described spots to be aligned with light emitting facets 31a-33a. The alignment targets 51-53 represent, for example, the centers of three single mode fibers used in conjunction with a wavelength division multiplexer, as shown and described in U.S. Pat. No. 6,201,908, referenced above. A noted above, each of the alignment targets 51-53 is commonly about 1 micron in size. As shown in FIG. 3, light emitting facet 31a is approximately 5 microns above target 51 on the y-axis; facet 32a is approximately 4 microns below target 52 on the y-axis, and facet 33a is approximately 10 microns above (on the y-axis) and 5 microns to the left (on the x-axis) of target 53. The misalignment of facets 31a-33a with targets 51-53 shown in FIG. 3 represents the prior art difficulty of using low cost, edge emitting laser diodes 31-33 in wavelength division multiplexers; the misalignment is unacceptable and a wavelength division multiplexer with this misalignment would not function.

FIG. 4 illustrates schematically how the present invention will operate successfully with the same variable thickness edge emitting diode lasers 31-33 shown in FIG. 3. In FIG. 4, each diode laser 31-33 is attached to an adjustable submount 61-63. Each adjustable submount 61, 62 and 63 is movable on the x and y axes in order to align each light emitting facet 31a, 32a and 33a with targets 51-53. The desired alignment is shown in FIG. 4. Facet 31a has been aligned with target 51 by moving adjustable submount 61a downwardly on the y-axis as shown by arrow 61a. Facet 32a has been aligned with target 52 by moving adjustable submount 62 upwardly on the y-axis as shown by arrow 62a. Facet 33a has been aligned with target 53 by moving adjustable submount 63 downwardly on the y-axis as shown by arrow 63a and to the right on the x-axis as shown by arrow 63b.

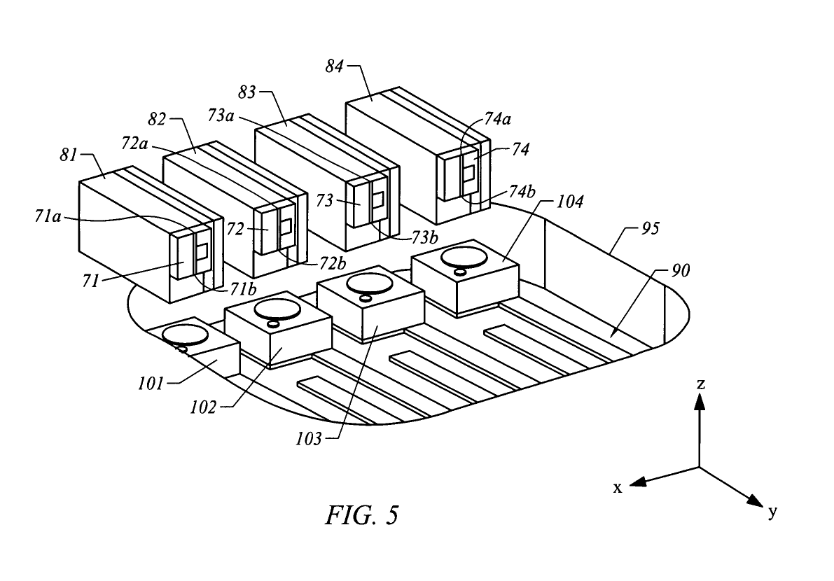

FIG. 5 is a perspective view of an array of four edge emitting laser diodes 71-74. As shown in FIG. 5, the “array” is a one dimensional array of four diodes spaced apart along the x-axis. The term “array,” as used herein and in the claims, is used broadly to include n edge emitting laser diodes, and one and two dimensional arrays (such as a 2×2 array) of edge emitting diode lasers. The x, y and z axes described herein are Cartesian coordinate axes. Each diode laser 71-74 is mounted on one of adjustable or movable submounts 81-84. Submounts 81-84 are adjustable along both the x and y axes to align the output beams emitted from light emitting facets 71a-74a with alignment targets not shown in FIG. 5. A base 90 lies in a plane including x and y axes, and light emitted from facets 71a-74a is emitted parallel to the z-axis around the periphery of base 90. Submounts 81-84 are adjustable relative to spacer 95 to allow movement of submounts 81-84 on the x and y axes. When submounts 81-84 have been moved or adjusted to align the light emitting facets 71a-74a with their respective “targets” (not shown in FIG. 5), submounts 81-84 are attached to spacer 95 by soldering, ultrasonic welding, or other means known in the art. An array of monitoring photodiodes 101-104 are mounted on base 90 to monitor the output of each edge emitting laser 71-74. The monitoring photodiodes 101-104 are aligned with the light emitting facets 71a-74a and receive light emitted from the rear faces 71b-74b of facets 71a-74a.

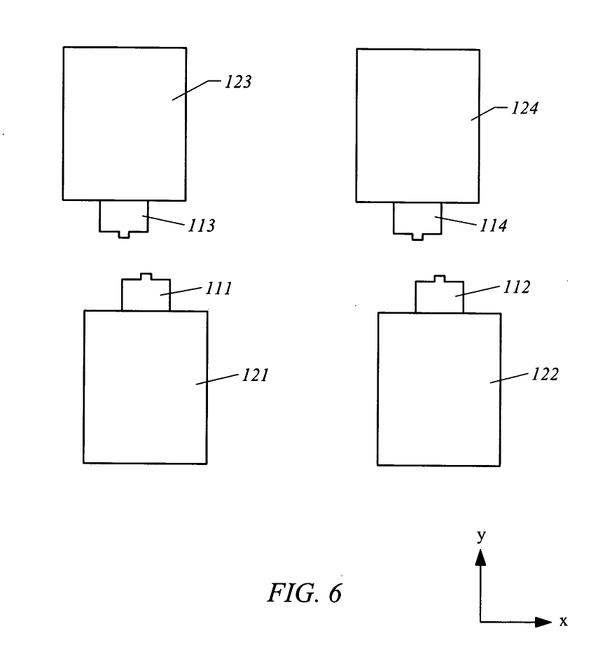

FIG. 6 is a schematic illustration showing how an array of four edge emitting diode lasers 111-114 may be positioned to form a two dimensional, 2×2 array with two diodes extending along the x-axis and two diodes extending along the y-axis.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A method of forming a laser diode assembly for use in optical communications systems, wherein said assembly includes a base and an array of edge emitting laser diodes, said edge emitting laser diodes having thickness variations that affect the location of light emitting facets of each diode, wherein said assembly is formed in relation to x, y and z Cartesian coordinates, wherein said base lies in a plane including said x and y axes, and wherein the light emitting facet of each of said edge emitting laser diodes emits light parallel to said z axis, and said light emitting facets must be aligned with each other and aligned with optical pathways of said optical communication system in relation to said x and y axes, comprising the steps:
mounting each of said array of edge emitting laser diodes on a separate submount,
adjusting each of said separate submounts along said x and/or y axes so that said light emitting facet of each edge emitting laser diode is aligned with optical pathways of said optical communication system and is also aligned with light emitting facets of other edge emitting laser diodes in said array, and
attaching each of said separate submounts relative to said base after said alignment has been obtained for each of said edge emitting laser diodes.

2. The method of claim 1 comprising the further step:
monitoring the output of each of said edge emitting laser diodes.

3. The method of claim 1 wherein said array includes n edge emitting laser diodes.

4. The method of claim 1 wherein said array is a two dimensional array extending along the x and y axes.

5. The method of claim 4 wherein said array is a two dimensional, 2×2 array.

6. An edge emitting laser diode assembly for use in an optical communication system, wherein said assembly is formed in relation to x, y and z Cartesian coordinates, comprising:
an array of n edge emitting laser diodes, wherein each laser diode has a light emitting facet that emits light parallel with said z-axis, and wherein said diodes have variations of thickness that affect the location of said light emitting facets of each diode along said x and/or y axes,
a plurality of n submounts, each of said n submounts carrying one of said n edge emitting laser diodes,
a base lying in a plane including said x and y axes,
wherein each of said n submounts is adapted to be mounted relative to said base and adjustable along said x and/or y axes for alignment of said laser diode light emitting facet carried by said submount with said optical communication system and with said other laser diode light emitting facets in said array, and
attachment means for connecting each of said submounts to said base when alignment of said light emitting facet of said laser diode carried by said submount is achieved.

7. The apparatus of claim 6 further comprising an array of n monitor photodiodes carried by said base for monitoring the output of each of said edge emitting laser diodes.

8. The apparatus of claim 6 wherein said array is a one dimensional array.

9. The apparatus of claim 6 wherein said array is a two dimensional array.

10. The apparatus of claim 6 wherein n=4.

11. The apparatus of claim 10 wherein said array is a 2×2 two dimensional array.
